(19) United States
(12) Patent Application Publication
(10) Pub. No.: US 2026/0194836 A1
(43) Pub. Date: Jul. 9, 2026

(54) ELECTROSTATIC CHARGE IMAGE DEVELOPING TONER SET, ELECTROSTATIC CHARGE IMAGE DEVELOPER SET, TONER CARTRIDGE SET, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Kohei MANABE, Kanagawa (JP); Yukiaki NAKAMURA, Kanagawa (JP)

(73) Assignee: FUJIFILM Business Innovation Corp., Tokyo (JP)

(21) Appl. No.: 19/298,174

(22) Filed: Aug. 12, 2025

(30) Foreign Application Priority Data
Jan. 9, 2025 (JP) 2025-003742

(51) Int. Cl. G03G 9/09; G03G 15/01; G03G 15/08; G03G 21/18

(52) U.S. Cl. CPC G03G 9/0922; G03G 9/0926; G03G 15/0126; G03G 15/0865; G03G 21/1814

(57) ABSTRACT

The electrostatic charge image developing toner set contains a fluorescent toner that contains a fluorescent colorant and has a brightness of 75 or more, and a non-fluorescent toner that contains no fluorescent colorant, in which an amount of Na⁺ on a surface of the fluorescent toner, that is measured by an ion chromatography method, is 0.005 mg/L or more and 0.050 mg/L or less, and a difference between the amount of Na⁺ on the surface of the fluorescent toner and an amount of Na⁺ on a surface of the non-fluorescent toner, that are measured by the ion chromatography method, is 0.050 mg/L or more, where the amount of Na⁺ is an amount of Na⁺ detected by a method in which 0.5 g of the fluorescent toner or the non-fluorescent toner is weighed, and then added to 100 g of deionized water at 30° C.±1° C., the mixture is dispersed by ultrasonic waves for 30 minutes, and then filtered through a filter, and the filtrate is analyzed by the ion chromatography method.

### CROSS-REFERENCE TO RELATED APPLICATIONS

This application is based on and claims priority under 35 USC 119 from Japanese Patent Application No. 2025-003742 filed Jan. 9, 2025.

### BACKGROUND

### (i) Technical Field

The present disclosure relates to an electrostatic charge image developing toner set, an electrostatic charge image developer set, a toner cartridge set, a process cartridge, an image forming apparatus, and an image forming method.

### (ii) Related Art

JP2012-68581A discloses an orange toner containing a binder resin including a polyester resin having a dodecenylsuccinic acid structure as a constitutional unit, and C.I. Pigment Orange 38 in a blending amount of 5% to 18% by mass with respect to the total mass of the toner.

JP2024-40063A discloses a toner set that has a white toner and a color toner, in which in a case where Cw [mg/L] represents an amount of a cation on a surface of the white toner measured by ion chromatography method and Cc [mg/L] represents an amount of a cation on a surface of the color toner measured by ion chromatography, the toner set satisfying Conditions (1) and (2).

$$0.3 mg / L \leq Cc \leq 1.2 mg / L \qquad ( 1 )$$

$$( Cw / Cc ) \leq 0.8 \qquad ( 2 )$$

### SUMMARY

Aspects of non-limiting embodiments of the present disclosure relate to an electrostatic charge image developing toner set in which color unevenness suppression property of an image to be obtained is excellent as compared with a case where an amount of Na⁺ on a surface of a fluorescent toner, that is measured by an ion chromatography method, is less than 0.005 mg/L or more than 0.050 mg/L, or a difference between the amount of Na⁺ on the surface of the fluorescent toner and an amount of Na⁺ on a surface of a non-fluorescent toner, that are measured by an ion chromatography method, is less than 0.050 mg/L.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object include the following aspects.

The electrostatic charge image developing toner set contains a fluorescent toner that contains a fluorescent colorant and has a brightness of 75 or more, and a non-fluorescent toner that contains no fluorescent colorant, in which an amount of Na⁺ on a surface of the fluorescent toner, that is measured by an ion chromatography method, is 0.005 mg/L or more and 0.050 mg/L or less, and a difference between the amount of Na⁺ on the surface of the fluorescent toner and an amount of Na⁺ on a surface of the non-fluorescent toner, that are measured by the ion chromatography method, is 0.050 mg/L or more, where the amount of Na⁺ is an amount of Na⁺ detected by a method in which 0.5 g of the fluorescent toner or the non-fluorescent toner is weighed, and then added to 100 g of deionized water at 30° C.±1° C., the mixture is dispersed by ultrasonic waves for 30 minutes, and then filtered through a filter, and the filtrate is analyzed by the ion chromatography method.

### BRIEF DESCRIPTION OF THE DRAWINGS

Exemplary embodiment(s) of the present invention will be described in detail based on the following figures, wherein:

FIG. 1 is a view schematically showing a configuration of an example of an image forming apparatus used in the present exemplary embodiment; and

FIG. 2 is a view schematically showing a configuration of an example of a process cartridge used in the present exemplary embodiment.

FIG. 3 is a diagram showing an example of a spectrum in each color of fluorescence. The vertical axis indicates the fluorescence intensity, and the horizontal axis indicates the wavelength.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” is an expression including both acrylic and methacrylic, and “(meth)acrylate” is an expression including both acrylate and methacrylate.

In the present disclosure, “electrostatic charge image developing toner” is also referred to as “toner”, “electrostatic charge image developer” is also referred to as “developer”, and “electrostatic charge image developing carrier” is also referred to as “carrier”.

### Electrostatic Charge Image Developing Toner Set

The electrostatic charge image developing toner set according to the present exemplary embodiment contains a fluorescent toner that contains a fluorescent colorant and has a brightness of 75 or more and a non-fluorescent toner that contains no fluorescent colorant, in which an amount of Na⁺ on a surface of the fluorescent toner, that is measured by an ion chromatography method, is 0.005 mg/L or more and 0.050 mg/L or less, and a difference between the amount of Na⁺ on the surface of the fluorescent toner and an amount of Na⁺ on a surface of the non-fluorescent toner, that are measured by the ion chromatography method, is 0.050 mg/L or more.

Here, the amount of Na⁺ is an amount of Na⁺ detected by a method in which 0.5 g of the fluorescent toner or the non-fluorescent toner is weighed, and then added to 100 g of deionized water at 30° C.±1° C., the mixture is dispersed by ultrasonic waves for 30 minutes, and then filtered through a filter, and the filtrate is analyzed by the ion chromatography method.

In the related art, in a case of producing a secondary color image with a non-fluorescent toner using a fluorescent toner having a high brightness, such as a fluorescent toner that contains a fluorescent colorant and has a brightness of 75 or more, with the fluorescent toner, since a fluorescence intensity of the image to be obtained is greatly changed between an arrangement portion where the non-fluorescent toner is present on the upper layer and an arrangement portion where the non-fluorescent toner is not present, in the secondary color image, the fluorescence intensity is changed in a portion where the toner arrangement is broken (for example, a portion where the top and bottom of the arrangement of the fluorescent toner and the non-fluorescent toner are swapped), resulting in color unevenness.

In the electrostatic charge image developing toner set according to the present exemplary embodiment, since the amount of Na⁺ on the surface of the fluorescent toner, that is measured by an ion chromatography method, is 0.005 mg/L or more and 0.050 mg/L or less, and the difference between the amount of Na⁺ on the surface of the fluorescent toner and the amount of Na⁺ on the surface of the non-fluorescent toner, that are measured by the ion chromatography method, is 0.050 mg/L or more, the amount of Na⁺ on the surface of the toner acts as a factor controlling hydrophilicity of the surface of the toner, and a difference in hydrophilicity of the surface can be set between the fluorescent toner and the non-fluorescent toner. Therefore, it is presumed that mixing of the fluorescent toner and the non-fluorescent toner can be suppressed, and thus color unevenness suppression property of the image to be obtained is excellent.

Hereinafter, the configuration of the electrostatic charge image developing toner set according to the present exemplary embodiment will be described in detail.

Amount of Na⁺ on Surface of Fluorescent Toner or Non-fluorescent Toner

The amount of Na⁺ on the surface of the fluorescent toner described above is 0.005 mg/L or more and 0.050 mg/L or less, and from the viewpoint of color unevenness suppression property in an image to be obtained (hereinafter, also simply referred to as “color unevenness suppression property”), the amount is, for example, preferably 0.010 mg/L or more and 0.040 mg/L or less, and more preferably 0.020 mg/L or more and 0.040 mg/L or less.

From the viewpoint of color unevenness suppression property, the amount of Na⁺ on the surface of the non-fluorescent toner is, for example, preferably 0.030 mg/L or more and 0.600 mg/L or less, more preferably 0.050 mg/L or more and 0.500 mg/L or less, still more preferably 0.070 mg/L or more and 0.300 mg/L or less, and particularly preferably 0.110 mg/L or more and 0.140 mg/L or less.

A method of measuring the amount of Na⁺ on the surface of the fluorescent toner or the non-fluorescent toner according to the present exemplary embodiment is a method of measuring the amount of Na ions (amount of Na⁺) detected in a case where 0.5 g of the toner to be measured is weighed, added to 100 g of deionized water at 30° C.±1° C., dispersed by ultrasonic waves for 30 minutes, and then filtered through a filter, and the filtrate is analyzed by the ion chromatography method.

Specifically, the amount of Na⁺ on the surface of the toner is measured as follows.

First, 0.5 g of the toner to be measured is weighed, and dispersed to 100 g of deionized water to which 0.1 g of a nonionic surfactant (NONIPOL 10 manufactured by Sanyo Chemical Industries, Ltd.) corresponding to 20% of the solid content of the toner has been added, and the mixture is dispersed in the deionized water for 30 minutes using an ultrasonic disperser in a constant temperature tank controlled at 30° C.±1° C.

The solution after the ultrasonic shaking is subjected to suction filtration to separate a solid and a liquid and remove the solid toner, and the obtained filtrate is measured by an ion chromatography method. For the ion chromatography method, ICS-2000 manufactured by Nippon Dionex K.K. is used, and the analysis is performed under the following conditions.
Cation separation column: manufactured by Nippon Dionex K.K., IonPac CS12A
Anion guard column: manufactured by Nippon Dionex K.K., IonPac CG12A
Eluent: 20 mM methanesulfonic acid
Flow rate: 1 ml/min
Temperature: 35° C.
Detection method: electrical conductivity method (suppressor type)
Difference between Amount of Na⁺ on Surface of Fluorescent Toner and Amount of Na⁺ on Surface of Non-Fluorescent Toner

The difference between the amount of Na⁺ on the surface of the fluorescent toner and the amount of Na⁺ on the surface of the non-fluorescent toner, that are measured by the ion chromatography method, is 0.050 mg/L or more, and from the viewpoint of color unevenness suppression property, the difference is, for example, preferably 0.080 mg/L or more, more preferably 0.100 mg/L or more, still more preferably 0.100 mg/L or more and 0.600 mg/L or less, and particularly preferably 0.100 mg/L or more and 0.500 mg/L or less.

A method of adjusting the amount of Na⁺ on the surface of the fluorescent toner and the non-fluorescent toner is not particularly limited, and examples thereof include a method of adding a Na⁺ source, such as a sodium salt compound or an aqueous NaOH solution, during the aggregated particle-forming step or the coalescence step in the production of the toner particles, or after the toner particles are granulated and before the washing step.

### Fluorescent Toner and Non-Fluorescent Toner

The electrostatic charge image developing toner set according to the present exemplary embodiment contains a fluorescent toner that contains a fluorescent colorant and has a brightness of 75 or more, and a non-fluorescent toner that contains no fluorescent colorant.

Hereinafter, in a case of simply being referred to as “toner”, unless otherwise specified, both the fluorescent toner and the non-fluorescent toner are applied; and in a case of simply being referred to as “toner particles”, unless otherwise specified, both toner particles of the fluorescent toner and toner particles of the non-fluorescent toner are applied.

The brightness of the fluorescent toner is 75 or more, and from the viewpoint of further exhibiting the effect of the present exemplary embodiment, for example, the brightness is preferably 75 or more and 100 or less, and more preferably 79 or more and 97 or less.

In addition, from the viewpoint of further exhibiting the effect of the present exemplary embodiment, a value of a difference between the brightness of the fluorescent toner and a brightness of the non-fluorescent toner (Brightness of fluorescent toner−Brightness of non-fluorescent toner) is, for example, preferably 20 or more, and more preferably 25 or more. The upper limit value thereof is not particularly limited, and may be 100 or less.

The brightness of the toner in the present exemplary embodiment is measured by the following method.

As an image forming apparatus for forming an evaluation image, a modified machine of Color 1000 Press (FUJIFILM Business Innovation Corporation) is prepared, a developer is put into a developing device, and the toner is put into a toner cartridge.

A monochrome solid image (density: 100%, size: 5 cm×5 cm, toner coverage amount: 4.0 g/m²) is formed on one side of a coat paper (OS coat paper, 127 g/m², FUJIFILM Business Innovation Corporation) having an A4 size. A fixing temperature is set to 180° C.

Using a reflection spectrodensitometer X-Rite 939 (aperture diameter: 4 mm, manufactured by X-Rite, Inc.), an L* value in a CIE 1976 L*a*b* color system is measured at 10 locations in the solid image, an average value of the L* values is calculated, and the average value is defined as the brightness.

### Toner Particles

For example, it is preferable that the fluorescent toner has toner particles containing a fluorescent colorant.

In addition, the toner particles in the fluorescent toner contain a fluorescent colorant and a binder resin, and are configured to contain a release agent and other additives as necessary.

For example, it is preferable that the non-fluorescent toner has toner particles containing a colorant other than the fluorescent colorant.

In addition, the toner particles in the non-fluorescent toner contain a colorant other than the fluorescent colorant, a binder resin, and are configured to contain a release agent and other additives as necessary.

### Fluorescent Colorant

The fluorescent toner contains a fluorescent colorant.

In addition, the non-fluorescent toner does not contain a fluorescent colorant.

It is sufficient that the fluorescent colorant is a colorant exhibiting fluorescence, and for example, a colorant exhibiting fluorescence in a visible light region (a wavelength of 380 nm or more and 760 nm or less) is preferable. In addition, light for exciting the fluorescent colorant is not particularly limited, but for example, preferably visible light or light including at least ultraviolet light, and more preferably light including at least ultraviolet light.

Furthermore, the fluorescent colorant may be a fluorescent pigment or a fluorescent dye, but for example, preferably a fluorescent pigment.

In the present exemplary embodiment, the “pigment” is a colorant in which a solubility in 100 g of water at 23° C. and a solubility in 100 g of cyclohexanone at 23° C. are each less than 0.1 g; and the “dye” is a colorant in which the solubility in 100 g of water at 23° C. or the solubility in 100 g of cyclohexanone at 23° C. is 0.1 g or more.

In addition, color of the fluorescent colorant is not particularly limited, and may be appropriately selected depending on purposes.

Examples of the fluorescent colorant include a fluorescent pink colorant, a fluorescent red colorant, a fluorescent orange colorant, a fluorescent yellow colorant, a fluorescent green colorant, and a fluorescent purple colorant.

Among these, for example, a fluorescent pink colorant, a fluorescent red colorant, a fluorescent orange colorant, a fluorescent yellow colorant, or a fluorescent green colorant is preferable; a fluorescent pink colorant, a fluorescent yellow colorant, or a fluorescent green colorant is more preferable; and a fluorescent yellow colorant is still more preferable.

Among these, from the viewpoint of further exhibiting the effect of the present exemplary embodiment, the fluorescent colorant is, for example, particularly preferably an azomethine fluorescent pigment having a light emission peak in a wavelength range of 500 nm or more and 550 nm or less in a light emission spectrum.

The light emission peak of the fluorescent colorant in the spectral reflectance can be appropriately selected depending on purpose color. In a case of expressing fluorescent yellow as the color, for example, the fluorescent colorant preferably has a light emission peak of 500 nm or more and 550 nm or less. The light emission peak is measured by forming the fluorescent colorant into a disk shape and performing a measurement using a spectrophotometer eXact (registered trademark) (manufactured by X-Rite, Inc.).

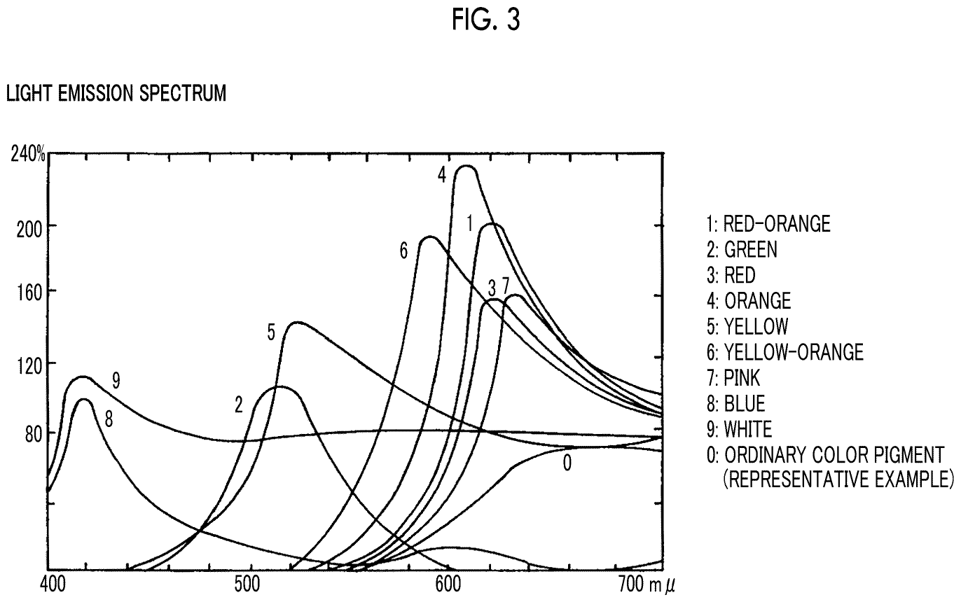

FIG. 3 shows an example of a spectrum in each color of the fluorescent color. The vertical axis indicates the fluorescence intensity, and the horizontal axis indicates the wavelength. Note that “mμ”=“nm”.

As the fluorescent colorant, a known fluorescent colorant can be used, and specific examples thereof include C.I. Pigment Yellow 101, Basic Red 1 (Rhodamine 6G), Basic Red 1:1, Basic Red 2, Basic Red 12, Basic Red 13, Basic Red 14, Basic Red 15, Basic Red 36, Basic Violet 7, Basic Violet 10 (Rhodamine B), Basic Violet 11 (Rhodamine 3B), Basic Violet 11:1 (Rhodamine A), Basic Violet 15, Basic Violet 16, Basic Violet 27, Basic Yellow 1, Basic Yellow 2, Basic Yellow 9, Basic Yellow 24, Basic Yellow 40, Basic Orange 15, Basic Orange 22, Basic Blue 1, Basic Blue 3, Basic Blue 7, Basic Blue 9, Basic Blue 45, Basic Green 1, Acid Yellow 3, Acid Yellow 7, Acid Yellow 73, Acid Yellow 87, Acid Yellow 184, Acid Yellow 245, Acid Yellow 250, Acid Red 51, Acid Red 52, Acid Red 57, Acid Red 77, Acid Red 87, Acid Red 89, Acid Red 92, Acid Blue 9, Acid Black 2, Solvent Yellow 43, Solvent Yellow 44, Solvent Yellow 85, Solvent Yellow 98, Solvent Yellow 116, Solvent Yellow 131, Solvent Yellow 145, Solvent Yellow 160:1, Solvent Yellow 172, Solvent Yellow 185, Solvent Yellow 195, Solvent Yellow 196, Solvent Orange 63, Solvent Orange 112, Solvent Red 49, Solvent Red 149, Solvent Red 175, Solvent Red 196, Solvent Red 197, Solvent Blue 5, Solvent Green 5, Solvent Green 7, Direct Yellow 27, Direct Yellow 85, Direct Yellow 96, Direct Orange 8, Direct Red 2, Direct Red 9, Direct Blue 22, Direct Blue 199, Direct Green 6, Disperse Yellow 11, Disperse Yellow 82, Disperse Yellow 139, Disperse Yellow 184, Disperse Yellow 186, Disperse Yellow 199, Disperse Yellow 202, Disperse Yellow 232, Disperse Orange 11, Disperse Orange 32, Disperse Red 58, Disperse Red 274, Disperse Red 277, Disperse Red 303, Disperse Blue 7, Reactive Yellow 78, and Vat Red 41.

The fluorescent toner may contain only one kind of fluorescent colorant, or may contain two or more kinds of fluorescent colorants.

From the viewpoint of fluorescence intensity and particulate property of the image, in a case where a pigment is used as the fluorescent colorant, a content of the fluorescent colorant is, for example, preferably 1% by mass or more and 15% by mass or less, more preferably 3% by mass or more and 10% by mass or less, and particularly preferably 5% by mass or more and 8% by mass or less with respect to the entire toner particles. In a case where a dye is used as the fluorescent colorant, a content of the fluorescent colorant is, for example, preferably 0.05% by mass or more and 2% by mass or less, more preferably 0.1% by mass or more and 1.5% by mass or less, and particularly preferably 0.5% by mass or more and 1.0% by mass or less with respect to the entire toner particles.

Colorant Other than Fluorescent Colorant

The fluorescent toner may contain a colorant other than the fluorescent colorant, and for example, it is preferable to contain a non-fluorescent pigment.

In addition, for example, it is preferable that the non-fluorescent toner contains a colorant other than the fluorescent colorant.

Specific examples of the colorant other than the fluorescent colorant include magenta pigments such as C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 21, C.I. Pigment Red 22, C.I. Pigment Red 23, C.I. Pigment Red 31, C.I. Pigment Red 32, C.I. Pigment Red 38, C.I. Pigment Red 41, C.I. Pigment Red 48, C.I. Pigment Red 48:1, C.I. Pigment Red 48:2, C.I. Pigment Red 48:3, C.I. Pigment Red 48:4, C.I. Pigment Red 49, C.I. Pigment Red 52, C.I. Pigment Red 53:1, C.I. Pigment Red 54, C.I. Pigment Red 57:1, C.I. Pigment Red 58, C.I. Pigment Red 60:1, C.I. Pigment Red 63, C.I. Pigment Red 64:1, C.I. Pigment Red 68, C.I. Pigment Red 81:1, C.I. Pigment Red 81:4, C.I. Pigment Red 83, C.I. Pigment Red 88, C.I. Pigment Red 89, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 170, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 206, C.I. Pigment Red 207, C.I. Pigment Red 208, C.I. Pigment Red 209, C.I. Pigment Red 210, C.I. Pigment Red 220, C.I. Pigment Red 221, C.I. Pigment Red 238, C.I. Pigment Red 242, C.I. Pigment Red 245, C.I. Pigment Red 253, C.I. Pigment Red 254, C.I. Pigment Red 255, C.I. Pigment Red 256, C.I. Pigment Red 258, C.I. Pigment Red 264, C.I. Pigment Red 266, C.I. Pigment Red 269, C.I. Pigment Red 282, and Pigment Violet 19; magenta dyes such as C.I. Solvent Red 1, C.I. Solvent Red 3, C.I. Solvent Red 8, C.I. Solvent Red 23, C.I. Solvent Red 24, C.I. Solvent Red 25, C.I. Solvent Red 27, C.I. Solvent Red 30, C.I. Solvent Red 49, C.I. Solvent Red 52, C.I. Solvent Red 58, C.I. Solvent Red 63, C.I. Solvent Red 81, C.I. Solvent Red 82, C.I. Solvent Red 83, C.I. Solvent Red 84, C.I. Solvent Red 100, C.I. Solvent Red 109, C.I. Solvent Red 111, C.I. Solvent Red 121, C.I. Solvent Red 122, C.I. Disperse Red 9, C.I. Basic red 1, C.I. Solvent Red 2, C.I. Solvent Red 9, C.I. Solvent Red 12, C.I. Solvent Red 13, C.I. Solvent Red 14, C.I. Solvent Red 15, C.I. Solvent Red 17, C.I. Solvent Red 18, C.I. Solvent Red 22, C.I. Solvent Red 23, C.I. Solvent Red 24, C.I. Solvent Red 27, C.I. Solvent Red 29, C.I. Solvent Red 32, C.I. Solvent Red 34, C.I. Solvent Red 35, C.I. Solvent Red 36, C.I. Solvent Red 37, C.I. Solvent Red 38, C.I. Solvent Red 39, and C.I. Solvent Red 40; and various pigments or various dyes such as Red iron oxide, Cadmium Red, Red lead, mercury sulfide, Permanent red 4R, Resole Red, Pyrazolone Red, Watching Red, calcium salt, Lake Red D, Brilliant Carmine 6B, Eosin Lake, Rotamine Rake B, Alizarin Rake, Brilliant Carmine 3B, Carbon Black, Chrome Yellow, Hansa Yellow, Benzidine Yellow, Slene Yellow, Quinoline Yellow, Pigment Yellow, Permanent Orange GTR, Pyrazolone Orange, Balkan Orange, Brilliant Carmine 3B, Brilliant Carmine 6B, DuPont Oil Red, Lake Red C, Aniline Blue, Ultramarine Blue, Chalco oil blue, methylene blue chloride, Phthalocyanine blue, Pigment blue, Phthalocyanine green, and Malachite green oxalate.

The colorant other than the fluorescent colorant may be used alone or in combination of two or more kinds thereof.

As the colorant other than the fluorescent colorant, a colorant having undergone a surface treatment as necessary may be used, or a dispersant may be used in combination with the colorant. In addition, a plurality of kinds of colorants may be used in combination.

As the non-fluorescent pigment in the fluorescent toner, for example, it is preferable to include a non-fluorescent pigment having a reflection peak in a wavelength range of 480 nm or more and 540 nm or less in a reflection spectrum. The reflection peak is measured by forming the non-fluorescent pigment into a disk shape and performing a measurement using a spectrophotometer eXact (registered trademark) (manufactured by X-Rite, Inc.).

In addition, for example, it is particularly preferable that the fluorescent colorant in the fluorescent toner includes the azomethine fluorescent pigment having a light emission peak in a wavelength range of 500 nm or more and 550 nm or less in the light emission spectrum, and the non-fluorescent pigment in the fluorescent toner includes the non-fluorescent pigment having a reflection peak in a wavelength range of 480 nm or more and 540 nm or less in the reflection spectrum. With the above-described aspect, a fluorescent green toner having excellent color developing property is obtained.

A content of the colorant other than the fluorescent colorant is, for example, preferably 1% by mass or more and 30% by mass or less, and more preferably 3% by mass or more and 15% by mass or less with respect to the entire non-fluorescent toner particles.

From the viewpoint of fluorescence intensity and color reproducibility, the content of the colorant other than the fluorescent colorant is, for example, preferably 0.1% by mass or more and 30% by mass or less, and more preferably 0.5% by mass or more and 15% by mass or less with respect to the entire fluorescent toner particles.

### Binder Resin

Examples of the binder resin include vinyl-based resins including a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known amorphous polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 5% by mass or more and 25% by mass or less) with respect to all binder resins.

In addition, from the viewpoint of low-temperature fixability and heat storage properties, for example, the binder resin preferably includes a crystalline resin, and more preferably includes a crystalline polyester resin.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

A number-average molecular weight (Mn) of the amorphous polyester resin is, for example, preferably 2,000 or more and 100,000 or less.

A molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC-HLC-8120GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, the same as the amorphous polyester resin.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

### Release Agent

Examples of the release agent include hydrocarbon-based wax; natural wax such as carnauba wax, rice wax, and candelilla wax; synthetic or mineral-petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include well-known additives such as a magnetic material, a charge control agent, and inorganic powder. The additives are incorporated into the toner particles as internal additives.

### Characteristics and the Like of Toner Particles

The toner particles may be toner particles that have a single-layer structure or toner particles having a so-called core/shell structure that is configured with a core portion (core particle) and a coating layer (shell layer) coating the core portion.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles and the toner are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (equivalent circular perimeter length)/(perimeter length) [(perimeter length of circle having the same projected area as particle image)/(perimeter length of particle projection image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobic agent is, for example, preferably 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2.0% by mass or less.

From the viewpoint of color unevenness suppression property, for example, it is preferable that a volume-average particle size of the fluorescent toner is larger than a volume-average particle size of the non-fluorescent toner.

In addition, from the viewpoint of color unevenness suppression property, the volume-average particle size of the fluorescent toner is, for example, preferably 4.5 μm or more and 7.0 μm or less, more preferably 5.0 μm or more and 6.5 μm or less, and particularly preferably 5.4 μm or more and 6.2 μm or less.

From the viewpoint of color unevenness suppression property, the volume-average particle size of the non-fluorescent toner is, for example, preferably 3.5 μm or more and 6.0 μm or less, more preferably 4.0 μm or more and 5.5 μm or less, and particularly preferably 4.3 μm or more and 5.1 μm or less.

### Manufacturing Method of Toner

The toner is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

In a case where the toner particles are manufactured by the aggregation and coalescence method, for example, the following manufacturing method is preferable:

A manufacturing method having a step of preparing a resin particle dispersion in which resin particles to be the binder resin are dispersed (a resin particle dispersion-preparing step); a step of preparing a colorant particle dispersion in which colorant particles (the fluorescent colorant, the colorant other than the fluorescent colorant, and the like) are dispersed (a colorant particle dispersion-preparing step); a step of aggregating mixed particles in a mixed dispersion obtained by mixing the resin particle dispersion with the colorant particle dispersion (in a dispersion obtained by mixing other particle dispersions as necessary) to form aggregated particles (aggregated particle-forming step); and a step of coalescing the aggregated particles by heating an aggregated particle dispersion in which the aggregated particles are dispersed to form toner particles (coalescence step).

Hereinafter, each of the steps will be specifically described.

### Resin Particle Dispersion-Preparing Step

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having a medium, a sand mill, and a dyno mill. Depending on the type of resin particles, the resin particles may be dispersed in the dispersion medium by using a transitional phase-transfer emulsification method. The transitional phase-transfer emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in a particulate form.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less. For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the binder resin particle dispersion. That is, the volume-average particle size of the particles, the dispersion medium, the dispersion method, and the content of the particles in the binder resin particle dispersion are also applied to the colorant particles to be dispersed in the colorant particle dispersion and the release agent particles to be dispersed in the release agent particle dispersion.

### Aggregated Particle-Forming Step

The resin particle dispersion, the colorant particle dispersion (for example, the fluorescent colorant dispersion and the non-fluorescent pigment dispersion), and the release agent particle dispersion are mixed with each other. Thereafter, in the mixed dispersion, the resin particles, the fluorescent organic pigment, the non-fluorescent organic pigment, and the release agent particles are hetero-aggregated such that aggregated particles are formed that have a diameter close to the diameter of the target toner particles and include the resin particles, the fluorescent organic pigment, the non-fluorescent organic pigments, and the release agent particles.

In addition, in the aggregated particle-forming step, for example, it is preferable to add an NH₄⁺ source such as an ammonium salt compound, ammonia, and an acid.

As the NH₄⁺ source, for example, an ammonium salt compound is preferable, and ammonium sulfate or ammonium chloride is more preferable.

Specifically, for example, an aggregating agent is added to the mixed dispersion, the pH of the mixed dispersion is adjusted such that the dispersion is acidic (for example, pH of 2 or more and 5 or less), and a dispersion stabilizer is added thereto as necessary. Thereafter, the dispersion is heated to a temperature of the glass transition temperature of the resin particles (specifically, for example, to a temperature equal to or higher than the glass transition temperature of the resin particles—30° C. and equal to or lower than the glass transition temperature of the resin particles—10° C.) such that the particles dispersed in the mixed dispersion are aggregated, thereby forming aggregated particles.

In the aggregated particle-forming step, for example, in a state where the mixed dispersion is agitated with a rotary shearing homogenizer, the aggregating agent may be added thereto at room temperature (for example, 25° C.), the pH of the mixed dispersion may be adjusted such that the dispersion is acidic (for example, pH of 2 or more and 5 or less), a dispersion stabilizer may be added to the dispersion as necessary, and then the dispersion may be heated.

Examples of the aggregating agent include a surfactant having polarity opposite to the polarity of the surfactant contained in the mixed dispersion, an inorganic metal salt, and a metal complex having a valency of 2 or more. In a case where a metal complex is used as the aggregating agent, the amount of the surfactant used is reduced, and the charging characteristics are improved.

In addition to the aggregating agent, an additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the resin particles is, for example, preferably 0.01 parts by mass or more and 5.0 parts by mass or less, and more preferably 0.1 parts by mass or more and less than 3.0 parts by mass.

### Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

In addition, for example, it is preferable that a step of adding a sodium hydroxide aqueous solution is provided after the formation of the toner particles and before the cleaning step described later. By adding a sodium hydroxide aqueous solution at the timing, the pH of the aqueous solution containing the toner particles is increased, and a large amount of Na⁺ is introduced into the surface of the toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Electrostatic Charge Image Developer Set

The electrostatic charge image developer set according to the present exemplary embodiment contains a first electrostatic charge image developer containing the fluorescent toner in the electrostatic charge image developing toner set according to the present exemplary embodiment, and a second electrostatic charge image developer containing the non-fluorescent toner in the electrostatic charge image developing toner set according to the present exemplary embodiment.

The electrostatic charge image developer set according to the present exemplary embodiment may be a one-component developer which contains each developer and only the toner in the toner set according to the present exemplary embodiment, or a two-component developer which is obtained by mixing the toner and a carrier together.

The carrier is not particularly limited, and examples thereof include known carriers. Examples of the carrier include a coated carrier obtained by coating the surface of a core material containing magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes a first image forming unit that forms a first image using the fluorescent toner in the electrostatic charge image developing toner set according to the present exemplary embodiment, a second image forming unit that forms a second image using the non-fluorescent toner in the electrostatic charge image developing toner set according to the present exemplary embodiment, a transfer unit that transfers the first image and the second image onto a recording medium, and a fixing unit that fixes the first image and the second image on the recording medium.

The image forming apparatus according to the present exemplary embodiment may have an aspect in which the image forming apparatus has, as the first or second image forming unit, image forming units each having an image holder, charging means that charges a surface of the image holder, electrostatic charge image forming means that forms an electrostatic charge image on the charged surface of the image holder, and a developing unit that develops the electrostatic charge image formed on the surface of the image holder by an electrostatic charge image developer as a toner image.

In addition, the image forming apparatus according to the present exemplary embodiment may have an aspect in which the image forming apparatus has an image holder, charging means that charges a surface of the image holder, electrostatic charge image forming means that forms an electrostatic charge image on the charged surface of the image holder, and a first or second developing unit that develops the electrostatic charge image formed on the surface of the image holder by an electrostatic charge image developer as a toner image, as the first or second image forming unit.

With the image forming apparatus according to the present exemplary embodiment, an image forming method (image forming method according to the present exemplary embodiment), that includes a first image forming step of forming a first image using the fluorescent toner in the electrostatic charge image developing toner set according to the present exemplary embodiment, a second image forming step of forming a second image using the non-fluorescent toner in the electrostatic charge image developing toner set according to the present exemplary embodiment, a transferring step of transferring the first image and the second image onto a recording medium, and a fixing step of fixing the first image and the second image on the recording medium, is performed.

As the image forming apparatus according to the present exemplary embodiment, well-known image forming apparatuses are used, such as a direct transfer-type apparatus that transfers a toner image (in the present exemplary embodiment, the first image and the second image) formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including cleaning means that cleans the surface of the image holder before charging after the transfer of the toner image; and an apparatus including charge erasing means that erases charge by irradiating the surface of the image holder with charge erasing light before charging after the transfer of the toner image.

In the case of the intermediate transfer-type apparatus, as the transfer unit, for example, a configuration having an intermediate transfer member with surface on which the toner image is to be transferred, primary transfer means that performs primary transfer to transfer the toner image formed on the surface of the image holder to the surface of the intermediate transfer member, and secondary transfer means that performs secondary transfer to transfer the toner image transferred to the surface of the intermediate transfer member to the surface of a recording medium is adopted.

In addition, from the viewpoint of further exhibiting the effect of the present exemplary embodiment, for example, it is preferable that at least a portion of the toner image includes a lower layer of the fluorescent toner and an upper layer of the non-fluorescent toner during the fixing.

In the image forming apparatus according to the present exemplary embodiment, for example, a portion including the developing unit may be a cartridge structure (process cartridge) attachable to and detachable from the image forming apparatus. As the process cartridge, for example, a process cartridge is suitably used which includes a developing unit that accommodates the electrostatic charge image developer set according to the present exemplary embodiment.

Hereinafter, an example of the image forming apparatus will be described. Hereinafter, among the parts shown in the drawings, main parts will be described, and others will not be described.

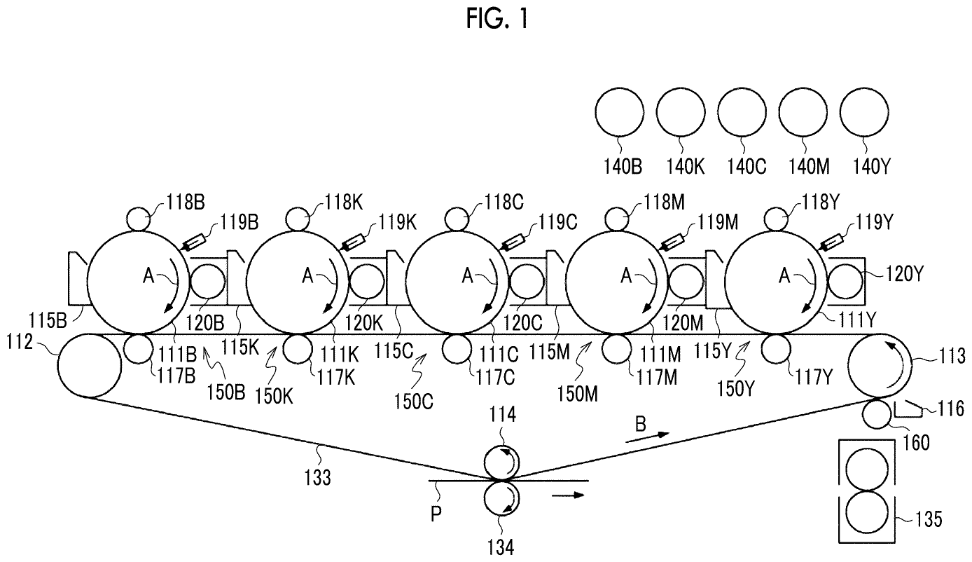

FIG. 1 is a view schematically showing the configuration of the image forming apparatus used in the present exemplary embodiment, that shows an intermediate transfer-type 5-unit tandem image forming apparatus.

The image forming apparatus shown in FIG. 1 includes first to fifth image forming units 150Y, 150M, 150C, 150K, and 150B (image forming unit) adopting an electrophotographic method that output images of colors, yellow (Y), magenta (M), cyan (C), black (K), and fluorescent color (B), based on color-separated image data. The image forming units (hereinafter, may be simply referred to as “units”) 150Y, 150M, 150C, 150K, and 150B are arranged in a row in the horizontal direction in a state of being spaced apart by a predetermined distance. The units 150Y, 150M, 150C, 150K, and 150B may be process cartridges that are attachable to and detachable from the image forming apparatus.

An intermediate transfer belt (an example of the intermediate transfer member) 133 passing through below the units 150Y, 150M, 150C, 150K, and 150B extends under the units. The intermediate transfer belt 133 is looped around a driving roll 113, a support roll 112, and a facing roll 114 that are in contact with the inner surface of the intermediate transfer belt 133, and runs toward the fifth unit 150B from the first unit 150Y (in FIG. 1, a direction of an arrow B). An intermediate transfer member cleaning device 116 facing the driving roll 113 is provided on the image holding surface side of the intermediate transfer belt 133. In addition, on the upstream side in the rotation direction of the intermediate transfer belt 133 with respect to the intermediate transfer member-cleaning device 116, a voltage applying device 160 is provided that makes a potential difference between the intermediate transfer belt 133 and the driving roll 113 such that an electric field is generated between the intermediate transfer belt 133 and the driving roll 113.

Yellow, magenta, cyan, black, and fluorescent color toners contained in containers of toner cartridges 140Y, 140M, 140C, 140K, and 140B are supplied to developing devices (an example of developing unit) 120Y, 120M, 120C, 120K, and 120B of the units 150Y, 150M, 150C, 150K, and 150B, respectively.

The first to fifth units 150Y, 150M, 150C, 150K, and 150B have the same configuration and action and perform the same operation. Therefore, in the present specification, as a representative, the first unit 150Y that is placed on the upstream side of the running direction of the intermediate transfer belt and forms a yellow image will be described.

The first unit 150Y has a photoreceptor 111Y that acts as an image holder. Around the photoreceptor 111Y, a charging roll (an example of the charging means) 118Y that charges the surface of the photoreceptor 111Y at a predetermined potential, an exposure device (an example of the electrostatic charge image forming means) 119Y that exposes the charged surface to a laser beam based on color-separated image signals to form an electrostatic charge image, the developing device (an example of the developing unit) 120Y that develops the electrostatic charge image by supplying a toner to the electrostatic charge image, a primary transfer roll (an example of the primary transfer means) 117Y that transfers the developed toner image onto the intermediate transfer belt 133, and a photoreceptor cleaning device (an example of the cleaning means) 115Y that removes the residual toner on the surface of the photoreceptor 111Y after the primary transfer are arranged in this order.

The primary transfer roll 117Y is arranged on the inner side of the intermediate transfer belt 133, at a position facing the photoreceptor 111Y. A bias power supply (not shown in the drawing) for applying a primary transfer bias is connected to primary transfer rolls 117Y, 117M, 117C, 117K, and 117B of each unit. Each bias power supply changes a value of the transfer bias applied to each primary transfer roll under the control of a control unit not shown in the drawing.

Hereinafter, the operation that the first unit 150Y carries out to form a yellow image will be described.

First, prior to the operation, the surface of the photoreceptor 111Y is charged to a potential from −600 V to −800 V by the charging roll 118Y.

The photoreceptor 111Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 119Y, the laser beam is radiated to the surface of the charged photoreceptor 111Y according to the image data for yellow transmitted from the control unit not shown in the drawing. As a result, an electrostatic charge image of the yellow image pattern is formed on the surface of the photoreceptor 111Y

The electrostatic charge image is an image formed on the surface of the photoreceptor 111Y by charging. The image is a so-called negative latent image formed in a manner in which the charges with which the surface of the photoreceptor 111Y is charged flow due to the reduction in the specific resistance of the portion of the photosensitive layer irradiated with the laser beam from the exposure device 119Y, but the charges in a portion not being irradiated with the laser beam remain.

The electrostatic charge image formed on the photoreceptor 111Y rotates to a predetermined development position as the photoreceptor 111Y runs. At the development position, the electrostatic charge image on the photoreceptor 111Y is developed as a toner image by the developing device 120Y and visualized.

The developing device 120Y contains, for example, an electrostatic charge image developer that contains at least a yellow toner and a carrier. By being agitated in the developing device 120Y, the yellow toner undergoes triboelectrification, carries charges of the same polarity (negative polarity) as the charges with which the surface of the photoreceptor 111Y is charged, and is held on a developer roll (an example of a developer holder). As the surface of the photoreceptor 111Y passes through the developing device 120Y, the yellow toner electrostatically adheres to the neutralized latent image portion on the surface of the photoreceptor 111Y, and the latent image is developed by the yellow toner. The photoreceptor 111Y on which the yellow toner image is formed keeps on running at a predetermined speed, and the toner image developed on the photoreceptor 111Y is transported to a predetermined primary transfer position.

In a case where the yellow toner image on the photoreceptor 111Y is transported to the primary transfer position, a primary transfer bias is applied to the primary transfer roll 117Y, and electrostatic force heading for the primary transfer roll 117Y from the photoreceptor 111Y acts on the toner image. As a result, the toner image on the photoreceptor 111Y is transferred onto the intermediate transfer belt 133. The transfer bias applied at this time has a polarity (+) opposite to the polarity (−) of the toner. In the first unit 150Y, the transfer bias is set, for example, to +10 μA under the control of the control unit (not shown in the drawing).

On the other hand, the residual toner on the photoreceptor 111Y is removed by a photoreceptor cleaning device 115Y and collected.

The primary transfer bias applied to the primary transfer rolls 117M, 117C, 117K, and 117B following the second unit 150M is also controlled according to the first unit.

In this manner, the intermediate transfer belt 133 to which the yellow toner image is transferred in the first unit 150Y is sequentially transported through the second to fifth units 150M, 150C, 150K, and 150B, and the toner images of each color are superimposed and transferred in layers.

The intermediate transfer belt 133, to which the toner images of five colors are transferred in layers through the first to fifth units, reaches a secondary transfer portion configured with the intermediate transfer belt 133, the facing roll 114 in contact with the inner surface of the intermediate transfer belt 133, and a secondary transfer roll (an example of secondary transfer means) 134 arranged on the image holding surface side of the intermediate transfer belt 133. On the other hand, via a supply mechanism, recording paper P (an example of recording medium) is fed at a predetermined timing to the gap between the secondary transfer roll 134 and the intermediate transfer belt 133 that are in contact with each other. Furthermore, secondary transfer bias is applied to the facing roll 114. The transfer bias applied at this time has the same polarity (−) as the polarity (−) of the toner. The electrostatic force heading for the recording paper P from the intermediate transfer belt 133 acts on the toner image, which makes the toner image on the intermediate transfer belt 133 transferred onto the recording paper P. The secondary transfer bias to be applied at this time is determined according to the resistance detected by resistance detecting means (not shown in the drawing) for detecting the resistance of the secondary transfer portion, and the voltage thereof is controlled.

Thereafter, the recording paper P is transported into a pressure contact portion (nip portion) of a pair of fixing rolls in a fixing device 135 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

The image forming apparatus shown in FIG. 1 is an image forming apparatus having a configuration that enables the toner cartridges 140Y, 140M, 140C, 140K, and 140B to be attachable to and detachable from the apparatus. The developing devices 120Y, 120M, 120C, 120K, and 120B are connected to the toner cartridges corresponding to the respective developing devices (colors) by a toner supply pipe not shown in the drawing. In addition, in a case where the amount of the toner contained in the container of the toner cartridge is low, the toner cartridge is replaced.

### Process Cartridge and Toner Cartridge Set

The process cartridge according to the present exemplary embodiment includes a first developing unit containing the first electrostatic charge image developer in the electrostatic charge image developer set according to the present exemplary embodiment, and a second developing unit containing the second electrostatic charge image developer in the electrostatic charge image developer set according to the present exemplary embodiment, in which the process cartridge is attachable to and detachable from an image forming apparatus.

The process cartridge is not limited to the above-described configuration. The process cartridge may be configured with a developing device and, for example, at least one member selected from other means, such as an image holder, charging means, electrostatic charge image forming means, and a transfer unit, as necessary.

An example of the process cartridge will be shown below, but the present invention is not limited thereto. Hereinafter, among the parts shown in the drawing, main parts will be described, and others will not be described.

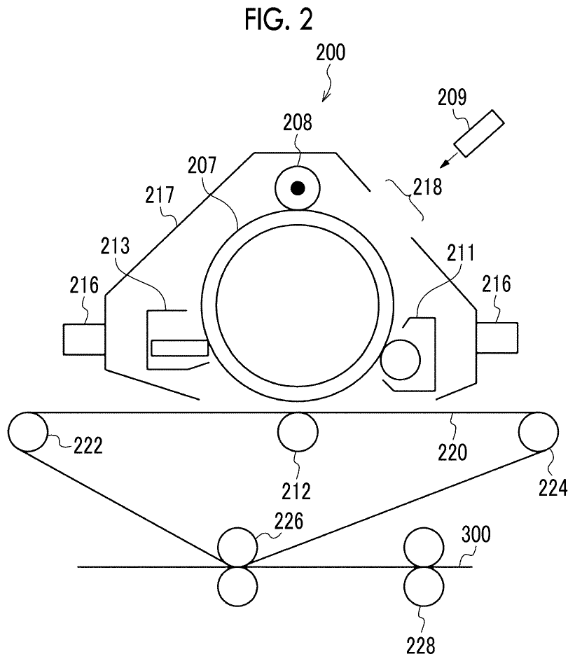

FIG. 2 is a view schematically showing the configuration of the process cartridge used in the present exemplary embodiment.

A process cartridge 200 shown in FIG. 2 is configured, for example, with a housing 217 that includes mounting rails 216 and an opening portion 218 for exposure, a photoreceptor 207 (an example of image holder), a charging roll 208 (an example of charging means) that is provided on the periphery of the photoreceptor 207, a developing device 211 (an example of developing unit), a photoreceptor cleaning device 213 (an example of cleaning means), that are integrally combined and held in the housing 217. The process cartridge 200 forms a cartridge in this way.

In FIG. 2, 209 represents an exposure device (an example of electrostatic charge image forming means), 212 represents a primary transfer roll (an example of primary transfer means), 220 represents an intermediate transfer belt (an example of an intermediate transfer member), 222 represents a driving roll that also functions as intermediate transfer belt-neutralizing means (an example of intermediate transfer member-neutralizing means), 224 represents a support roll, 226 represents a secondary transfer roll (an example of secondary transfer means), 228 represents a fixing device (an example of a fixing unit), and 300 represents recording paper (an example of a recording medium).

### EXAMPLES

Hereinafter, exemplary embodiments of the present invention will be specifically described based on examples. However, the exemplary embodiments of the present invention are not limited to the examples.

In the following description, unless otherwise specified, “parts” and “%” are based on mass.

Unless otherwise specified, synthesis, treatment, manufacturing, and the like were carried out at room temperature (25° C.±3C).

### Example 1

### Production of Fluorescent Toner (Toner 1)

### Preparation of Colorant Particle Dispersion (1)

Fluorescent yellow pigment (C.I. Pigment Yellow 101, Lumogen Yellow S 0795, BASF Japan Ltd.): 70 parts
Anionic surfactant (manufactured by DKS Co., Ltd., NEOGEN RK): 30 parts (concentration of solid content 20%)
Deionized water: 200 parts

The above components are mixed together and pulverized with a continuous key mill (KMC-3) to 0.5 μm, and the amount of solid content is adjusted to 20% by mass, thereby obtaining a colorant particle dispersion (1).

### Preparation of Colorant Particle Dispersion (2)

Green pigment (C.I. Pigment Green 36, Fastogen green 2YK, DIC Corporation): 70 parts
Anionic surfactant (manufactured by DKS Co., Ltd., NEOGEN RK): 30 parts (concentration of solid content 20%)
Deionized water: 200 parts

The above components are mixed, dispersed with a high-pressure impact disperser (ARTIMIZER HJP30006, manufactured by Sugino Machine Limited) for 1 hour, crushed to 0.15 m, and adjusted to a solid content of 20% by mass, thereby obtaining a colorant particle dispersion liquid (2).

### Preparation of Resin Particle Dispersion (1)

Terephthalic acid: 30 parts by mole
Fumaric acid: 70 parts by mole
Ethylene oxide adduct of bisphenol A: 5 parts by mole
Propylene oxide adduct of bisphenol A: 95 parts by mole

The above materials were put in a flask equipped with a stirrer, a nitrogen introduction tube, a temperature sensor, and a rectifying column, the temperature was raised to 220° C. for an hour, and titanium tetraethoxide was added thereto in an amount of 1 part with respect to 100 parts of the above materials. While the generated water was being distilled off, the temperature was raised to 230° C. for 30 minutes, a dehydration condensation reaction was continued for 1 hour at 230° C., and then the reactant was cooled. In this manner, a polyester resin having a weight-average molecular weight of 18,000 and a glass transition temperature of 60° C. was obtained.

40 parts of ethyl acetate and 25 parts of 2-butanol were put in a container equipped with temperature control means and nitrogen purge means, thereby preparing a mixed solvent. Then, 100 parts of the polyester resin was slowly added to and dissolved in the solvent, a 10% by mass aqueous ammonia solution (in an amount equivalent to 3 times the acid value of the resin in terms of molar ratio) was added thereto, and the mixed solution was stirred for 30 minutes. Next, the inside of the vessel was replaced with dry nitrogen, the temperature was kept at 40° C., and 400 parts of deionized water was added dropwise to the mixed solution at a rate of 2 parts/min while agitating the mixed solution. After the dropwise addition was completed, the temperature was returned to room temperature (20° C. to 25° C.), and bubbling was performed under agitating for 48 hours using dry nitrogen, thereby obtaining a resin particle dispersion in which the concentration of ethyl acetate and 2-butanol was reduced to 1,000 ppm or less. Deionized water is added to the above-described resin particle dispersion to adjust the solid content to 20% by mass, thereby obtaining a resin particle dispersion (1).

### Preparation of Release Agent Particle Dispersion (1)

Paraffin wax (manufactured by NIPPON SEIRO CO., LTD., HNP-9): 100 parts
Anionic surfactant (manufactured by DKS Co., Ltd., NEOGEN RK): 1 part
Deionized water: 350 parts

The above materials are mixed together, heated to 100° C., and dispersed using a homogenizer (IKA, trade name: ULTRA-TURRAX T50). Then, by using Munton Gorlin high-pressure homogenizer (Gorlin), dispersion treatment is performed, thereby obtaining a release agent particle dispersion (1) (solid content of 20% by mass) in which release agent particles having a volume-average particle size of 200 nm are dispersed.

### Production of Toner Particles (1)

Resin particle dispersion (1): 400 parts
Colorant particle dispersion (1): 50 parts
Colorant particle dispersion (2): 25 parts
Release agent particle dispersion (1): 25 parts
Anionic surfactant (manufactured by DKS Co., Ltd., NEOGEN RK, 20%): 10 parts

The above-described materials are charged into a round stainless flask, 0.1 N (=mol/L) nitric acid is added thereto to adjust the pH to 3.5, and 30 parts of a nitric acid aqueous solution of polyaluminum chloride with a concentration of 10% by mass is added thereto. Next, the mixture is dispersed at a liquid temperature of 30° C. using a homogenizer (manufactured by IKA, trade name ULTRA-TURRAX T50), heated to 45° C. in an oil bath for heating, and retained for 30 minutes. Thereafter, 50 parts of the resin particle dispersion (1) is added thereto, the reaction solution is kept as it is for 1 hour, 80 parts of a 0.1N (=mol/L) sodium hydroxide aqueous solution is added thereto such that the pH is adjusted to 8.5, and the reaction solution is heated to 84° C. and kept as it is for 2.5 hours. Next, the mixture is cooled to 20° C. at a rate of 20° C./min, 2.5 parts of a 0.1 N sodium hydroxide aqueous solution is added thereto, the solid content is separated by filtration, the mixture is sufficiently washed with 10,000 parts of deionized water, and dried to obtain toner particles (1). The volume-average particle size of the toner particles (1) is 5.8 μm.

### Production of Carrier 1

Ferrite particles (average particle size: 35 m): 100 parts
Toluene: 14 parts
Polymethylmethacrylate (MMA, weight-average molecular weight: 75,000): 5 parts
Carbon black: 0.2 parts (VXC-72, manufactured by Cabot Corporation., volume resistivity: 100 Ω·cm or less)

The above-described materials excluding the ferrite particles are dispersed with a sand mill, thereby preparing a dispersion. The dispersion is put in a vacuum deaerating kneader together with the ferrite particles, and dried under reduced pressure while being agitated, thereby obtaining a carrier 1.

### Production of Toner

1.5 parts by mass of hydrophobic silica (manufactured by Nippon Aerosil Co., Ltd., RY50) and 1.0 part by mass of hydrophobic titanium oxide (manufactured by Nippon Aerosil Co., Ltd., T805) with respect to 100 parts by mass of the obtained toner particles (1) are mixed together for 30 seconds using a sample mill with 10,000 revolutions per minute (rpm). Then, the obtained mixture is sieved using a vibration sieve having an opening size of 45 m, thereby preparing a toner 1 (electrostatic charge image developing toner). The volume-average particle size of the obtained toner 1 is 5.8 μm.

### Production of Electrostatic Charge Image Developer

The toner (8 parts) and 92 parts of the carrier are mixed together by using a V blender, thereby preparing a developer 1 (electrostatic charge image developer).

### Production of Non-Fluorescent Toner (Toner 2)

### Preparation of Colorant Particle Dispersion (3)

Cyan pigment (C.I. Pigment Blue 15:3, LIONOL BLUE FG-7330, manufactured by TOYOCOLOR CO., LTD.): 50 parts
Anionic surfactant (manufactured by DKS Co., Ltd., NEOGEN RK): 25 parts (concentration of solid contents: 20%)
Deionized water: 200 parts

The above-described components are mixed with each other and dispersed for 1 hour with a high-pressure impact disperser (ULTIMIZER HJP30006, SUGINO MACHINE LIMITED), thereby obtaining a colorant particle dispersion (3) having a volume-average particle size of 180 nm and a solid content of 20%.

### Production of Toner Particles (2)

Resin particle dispersion (1): 400 parts
Colorant particle dispersion (3): 50 parts
Release agent particle dispersion (1): 25 parts
Anionic surfactant (manufactured by DKS Co., Ltd., NEOGEN RK, 20%): 10 parts
Ammonium sulfate (manufactured by FUJIFILM Wako Pure Chemical Corporation): 0.10 parts

The above-described materials are charged into a round stainless flask, 0.1 N (=mol/L) nitric acid is added thereto to adjust the pH to 3.5, and 30 parts of a nitric acid aqueous solution of polyaluminum chloride with a concentration of 10% by mass is added thereto. Next, the mixture is dispersed at a liquid temperature of 30° C. using a homogenizer (manufactured by IKA, trade name ULTRA-TURRAX T50), heated to 45° C. in an oil bath for heating, and retained for 30 minutes. Thereafter, 50 parts of the resin particle dispersion (1) is added thereto, the reaction solution is kept as it is for 1 hour, a 0.1N sodium hydroxide aqueous solution is added thereto such that the pH is adjusted to 8.5, and the reaction solution is heated to 84° C. and kept as it is for 2.5 hours. Next, the reaction solution is cooled to 20° C. at a rate of 20° C./min, the solid contents are separated by filtration, thoroughly washed with deionized water, and dried, thereby obtaining toner particles (2). The volume-average particle size of the toner particles (2) is 4.7 μm.

### Production of Toner

1.5 parts by mass of hydrophobic silica (manufactured by Nippon Aerosil Co., Ltd., RY50) and 1.0 part by mass of hydrophobic titanium oxide (manufactured by Nippon Aerosil Co., Ltd., T805) with respect to 100 parts by mass of the obtained toner particles (2) are mixed together for 30 seconds using a sample mill with 10,000 rpm (revolutions per minute). Thereafter, the mixture is classified using a vibration sieve with an opening of 45 m, thereby preparing a toner 2 (cyan toner). The volume-average particle size of the obtained toner 2 is 4.7 μm.

### Production of Electrostatic Charge Image Developer

8 parts of the toner 2 and 92 parts of the carrier 1 are mixed with each other in a V-blender to produce a developer 2 (electrostatic charge image developer).

### Examples 2 to 9 and 14 to 18, and Comparative Examples 1 to 3

Each toner and each developer were prepared in the same manner as in Example 1, except that the amount of the 0.1 N sodium hydroxide aqueous solution used before the washing step in the preparation of the toner 1 and the toner 2 was adjusted and set as the amount of Na⁺ on the surface of each toner shown in Table 1.

### Example 10

A toner and a developer were each produced in the same manner as in Example 1, except that, in the production of the toner particles of the fluorescent toner, the temperature of the heating step after the dispersion by the homogenizer was changed from 48° C. to 47° C., the retaining time was changed from 30 minutes to 10 minutes, and the volume-average particle size of the obtained toner particles was changed to 5.4 μm.

### Example 11

A toner and a developer were each produced in the same manner as in Example 1, except that, in the production of the toner particles of the fluorescent toner, the temperature of the heating step after the dispersion by the homogenizer was changed from 48° C. to 49° C., the retaining time was changed from 30 minutes to 45 minutes, and the volume-average particle size of the obtained toner particles was changed to 6.2 μm.

### Example 12

Toners (fluorescent yellow (Y) toner and cyan toner) and developers were each produced in the same manner as in Example 3, except that, in the production of the toner particles of the fluorescent toner, the colorant particle dispersion (2) was not used and 50 parts of the fluorescent pigment particle dispersion (1) was used.

### Example 13

### Preparation of Colorant Particle Dispersion (4)

Magenta pigment (C.I. Pigment Red 122, FASTOGEN SUPER MAGENTA R, manufactured by DIC Corporation): 50 parts
Anionic surfactant (manufactured by DKS Co., Ltd., NEOGEN RK): 25 parts (concentration of solid contents: 20%)
Deionized water: 200 parts

The above-described components were mixed with each other and dispersed for 1 hour with a high-pressure impact disperser (ULTIMIZER HJP30006, SUGINO MACHINE LIMITED), thereby obtaining a colorant particle dispersion (4) having a volume-average particle size of 160 nm and a solid content of 20%.

Toners (fluorescent yellow (Y) toner and magenta toner) and developers were each produced in the same manner as in Example 8, except that, in the production of the toner particles of the non-fluorescent toner, the colorant particle dispersion (4) was used instead of the colorant particle dispersion (3).

### Measuring Method of Amount of Na⁺ on Surface

The amount of Na⁺ ions on the surface of the toner is measured as follows.

First, 0.5 g of the toner to be measured is weighed, and dispersed to 100 g of deionized water to which 0.1 g of a nonionic surfactant (NONIPOL 10 manufactured by Sanyo Chemical Industries, Ltd.) corresponding to 20% of the solid content of the toner has been added, and the mixture is dispersed in the deionized water for 30 minutes using an ultrasonic disperser in a constant temperature tank controlled at 30° C.±1° C.

The solution after the ultrasonic shaking is subjected to suction filtration to separate a solid and a liquid and remove the solid toner, and the obtained filtrate is measured by an ion chromatography method. For the ion chromatography method, ICS-2000 manufactured by Nippon Dionex K.K. is used, and the analysis is performed under the following conditions.
Cation separation column: manufactured by Nippon Dionex K.K., IonPac CS12A
Anion guard column: manufactured by Nippon Dionex K.K., IonPac CG12A
Eluent: 20 mM methanesulfonic acid
Flow rate: 1 ml/min
Temperature: 35° C.
Detection method: electrical conductivity method (suppressor type)
Measurement of Volume-Average Particle Size

The volume-average particle size of the toner and the toner particles is measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is set to 50,000.

A volume cumulative distribution is drawn for a particle size range (channel) divided based on the measured particle size distribution from the small diameter side, and a particle size at which the cumulative distribution reached 50% is defined as the volume-average particle size D50v.

### Measurement of Brightness

### Image Formation

As an image forming apparatus for forming an evaluation image, a modified machine of Color 1000 Press (FUJIFILM Business Innovation Corporation) is prepared, a developer is put into a developing device, and the toner is put into a toner cartridge.

A monochrome solid image (density: 100%, size: 5 cm×5 cm, toner coverage amount: 4.0 g/m²) is formed on one side of a coat paper (OS coat paper, 127 g/m², FUJIFILM Business Innovation Corporation) having an A4 size. A fixing temperature is set to 180° C.

### Brightness

Using a reflection spectrodensitometer X-Rite 939 (aperture diameter: 4 mm, X-Rite, Inc.), an L* value in a CIE 1976 L*a*b* color system is measured at 10 locations in the solid image, and an average value of the L* values is calculated to measure a brightness.

### Evaluation of Color Unevenness Suppression Property

### Image Formation

As an image forming apparatus for forming an evaluation image, a modified machine of Color 1000 Press (FUJIFILM Business Innovation Corporation) is prepared, a developer is put into a developing device, and the toner is put into a toner cartridge.

A secondary color image (density: 100%, size: 5 cm×5 cm, toner coverage amount of each toner: 4.0 g/m²) of two toner colors is formed on one side of a coat paper (OS coat paper, 127 g/m², FUJIFILM Business Innovation Corporation) having an A4 size. A fixing temperature is set to 180° C.

### Difference Between Maximum Value and Minimum Value of Brightness

Colors at 10 random locations are measured with a reflection spectrodensitometer X-Rite 939, and a difference between the maximum value and the minimum value of the brightness is calculated and evaluated according to the following evaluation standard. As the difference between the maximum value and the minimum value of the brightness is smaller, the color unevenness suppression property is more excellent.
A: 0.4 or less
B: more than 0.4 and 0.8 or less
C: more than 0.8

### Evaluation of Charging Properties of Toner

1.5 g of the toner and 15 g of the carrier are weighed, and the mixture is agitated in a turbular mixer for 5 minutes in an environment of normal temperature and normal humidity (20° C. and 50% RH), and then a charge amount per unit mass of the toner is measured with a blow-off measuring device. As the charge amount is larger, the charging properties are more excellent.

The evaluation results are collectively shown in Table 1.

TABLE 1

| | | | | | | | | Volume- | | | |
|---|---|---|---|---|---|---|---|---|---|---|---|
| | | | | | | | | average | | | |
| | | | | | | | | particle | | Charging | Evaluation |
| | | | | | Amount of Na⁺ on surface | | | diameter of | | properties | of color |
| | Type of toner | | Brightness of toner | | (mg/L) | | | toner (μm) | | (μC/g) | unevenness |
| | Upper | Lower | Upper | Lower | Upper | Lower | | Upper | Lower | Lower | suppression |
| | layer | layer | layer | layer | layer | layer | Difference | layer | layer | layer | property |
| Example 1 | Cyan | Fluorescent | 49 | 79 | 0.105 | 0.005 | 0.100 | 4.7 | 5.8 | 50 | B |
| | | G | | | | | | | | | |
| Example 2 | Cyan | Fluorescent | 49 | 79 | 0.110 | 0.010 | 0.100 | 4.7 | 5.8 | 48 | A |
| | | G | | | | | | | | | |
| Example 3 | Cyan | Fluorescent | 49 | 79 | 0.130 | 0.030 | 0.100 | 4.7 | 5.8 | 46 | A |
| | | G | | | | | | | | | |
| Example 4 | Cyan | Fluorescent | 49 | 79 | 0.140 | 0.040 | 0.100 | 4.7 | 5.8 | 45 | A |
| | | G | | | | | | | | | |
| Example 5 | Cyan | Fluorescent | 49 | 79 | 0.150 | 0.050 | 0.100 | 4.7 | 5.8 | 43 | B |
| | | G | | | | | | | | | |
| Example 6 | Cyan | Fluorescent | 49 | 79 | 0.100 | 0.030 | 0.070 | 4.7 | 5.8 | 46 | B |
| | | G | | | | | | | | | |
| Example 7 | Cyan | Fluorescent | 49 | 79 | 0.080 | 0.030 | 0.050 | 4.7 | 5.8 | 46 | B |
| | | G | | | | | | | | | |
| Example 8 | Cyan | Fluorescent | 49 | 79 | 0.500 | 0.030 | 0.470 | 4.7 | 5.8 | 43 | A |
| | | G | | | | | | | | | |
| Example 9 | Cyan | Fluorescent | 49 | 79 | 0.550 | 0.030 | 0.520 | 4.7 | 5.8 | 43 | B |
| | | G | | | | | | | | | |
| Example 10 | Cyan | Fluorescent | 49 | 79 | 0.130 | 0.028 | 0.102 | 4.7 | 5.4 | 49 | A |
| | | G | | | | | | | | | |
| Example 11 | Cyan | Fluorescent | 49 | 79 | 0.130 | 0.029 | 0.101 | 4.7 | 6.2 | 43 | A |
| | | G | | | | | | | | | |
| Example 12 | Cyan | Fluorescent | 49 | 97 | 0.130 | 0.028 | 0.102 | 4.7 | 5.8 | 47 | A |
| | | Y | | | | | | | | | |
| Example 13 | Magenta | Fluorescent | 45 | 97 | 0.131 | 0.028 | 0.103 | 4.7 | 5.8 | 45 | A |
| | | Y | | | | | | | | | |
| Example 14 | Cyan | Fluorescent | 49 | 79 | 0.130 | 0.029 | 0.101 | 4.8 | 5.7 | 47 | A |
| | | G | | | | | | | | | |
| Example 15 | Cyan | Fluorescent | 49 | 79 | 0.132 | 0.030 | 0.102 | 5.1 | 5.8 | 46 | A |
| | | G | | | | | | | | | |
| Example 16 | Cyan | Fluorescent | 49 | 79 | 0.131 | 0.030 | 0.101 | 4.3 | 5.8 | 46 | A |
| | | G | | | | | | | | | |
| Example 17 | Cyan | Fluorescent | 49 | 79 | 0.240 | 0.030 | 0.210 | 4.7 | 5.8 | 46 | A |
| | | G | | | | | | | | | |
| Example 18 | Cyan | Fluorescent | 49 | 79 | 0.380 | 0.030 | 0.350 | 4.7 | 5.8 | 46 | A |
| | | G | | | | | | | | | |
| Comparative | Cyan | Fluorescent | 49 | 79 | 0.150 | 0.000 | 0.150 | 4.7 | 5.8 | 52 | C |
| Example 1 | | G | | | | | | | | | |
| Comparative | Cyan | Fluorescent | 49 | 79 | 0.150 | 0.060 | 0.090 | 4.7 | 5.8 | 40 | C |
| Example 2 | | G | | | | | | | | | |
| Comparative | Cyan | Fluorescent | 49 | 79 | 0.060 | 0.030 | 0.030 | 4.7 | 5.8 | 46 | C |
| Example 3 | | G | | | | | | | | | |

As shown in Table 1, the electrostatic charge image developing toner sets of Examples 1 to 18 are excellent in color unevenness suppression property in the image to be obtained, as compared with the electrostatic charge image developing toner sets of Comparative Examples 1 to 3.
(((1))) An electrostatic charge image developing toner set comprising:
a fluorescent toner that contains a fluorescent colorant and has a brightness of 75 or more; and
a non-fluorescent toner that contains no fluorescent colorant,
wherein an amount of Na⁺ on a surface of the fluorescent toner, that is measured by an ion chromatography method, is 0.005 mg/L or more and 0.050 mg/L or less, and
a difference between the amount of Na⁺ on the surface of the fluorescent toner and an amount of Na⁺ on a surface of the non-fluorescent toner, that are measured by the ion chromatography method, is 0.050 mg/L or more,
where the amount of Na⁺ is an amount of Na⁺ detected by a method in which 0.5 g of the fluorescent toner or the non-fluorescent toner is weighed, and then added to 100 g of deionized water at 30° C.±1° C., the mixture is dispersed by ultrasonic waves for 30 minutes, and then filtered through a filter, and the filtrate is analyzed by the ion chromatography method.
(((2))) The electrostatic charge image developing toner set according to (((1))),
wherein the difference between the amount of Na⁺ on the surface of the fluorescent toner and the amount of Na⁺ on the surface of the non-fluorescent toner, that are measured by the ion chromatography method, is 0.100 mg/L or more.
(((3))) The electrostatic charge image developing toner set according to (((1))) or (((2))),
wherein the amount of Na⁺ on the surface of the fluorescent toner is 0.010 mg/L or more and 0.040 mg/L or less.
(((4))) The electrostatic charge image developing toner set according to any one of (((1))) to (((3))),
wherein the amount of Na⁺ on the surface of the non-fluorescent toner is 0.050 mg/L or more and 0.500 mg/L or less.
(((5))) The electrostatic charge image developing toner set according to any one of (((1))) to (((4))),
wherein a volume-average particle size of the fluorescent toner is 5.4 μm or more and 6.2 μm or less.
(((6))) The electrostatic charge image developing toner set according to any one of (((1))) to (((5))),
wherein a volume-average particle size of the non-fluorescent toner is 4.3 μm or more and 5.1 μm or less.
(((7))) The electrostatic charge image developing toner set according to any one of (((1))) to (((6))),
wherein the fluorescent colorant includes an azomethine fluorescent pigment having a light emission peak in a wavelength range of 500 nm or more and 550 nm or less in a light emission spectrum.
(((8))) The electrostatic charge image developing toner set according to any one of (((1))) to (((7))),
wherein the fluorescent toner further contains a non-fluorescent pigment.
(((9))) The electrostatic charge image developing toner set according to (((8))),
wherein the non-fluorescent pigment in the fluorescent toner includes a non-fluorescent pigment having a reflection peak in a wavelength range of 480 nm or more and 540 nm or less in a reflection spectrum.
(((10))) An electrostatic charge image developer set comprising:
a first electrostatic charge image developer containing the fluorescent toner in the electrostatic charge image developing toner set according to any one of (((1))) to (((9))); and
a second electrostatic charge image developer containing the non-fluorescent toner in the electrostatic charge image developing toner set according to any one of (((1))) to (((9))).
(((11))) A toner cartridge set comprising:
a first toner cartridge that includes a container containing the fluorescent toner in the electrostatic charge image developing toner set according to any one of (((1))) to (((9))); and
a second toner cartridge that includes a container containing the non-fluorescent toner in the electrostatic charge image developing toner set according to any one of (((1))) to (((9))),
wherein the toner cartridge set is attachable to and detachable from an image forming apparatus.
(((12))) A process cartridge comprising:
a first developing unit containing the first electrostatic charge image developer in the electrostatic charge image developer set according to (((10))); and
a second developing unit containing the second electrostatic charge image developer in the electrostatic charge image developer set according to (((10))),
wherein the process cartridge is attachable to and detachable from an image forming apparatus.
(((13))) An image forming apparatus comprising:
a first image forming unit that forms a first image using the fluorescent toner in the electrostatic charge image developing toner set according to any one of (((1))) to (((9)));
a second image forming unit that forms a second image using the non-fluorescent toner in the electrostatic charge image developing toner set according to any one of (((1))) to (((9)));
a transfer unit that transfers the first image and the second image onto a recording medium; and
a fixing unit that fixes the first image and the second image on the recording medium.
(((14))) An image forming method comprising:
forming a first image using the fluorescent toner in the electrostatic charge image developing toner set according to any one of (((1))) to (((9)));
forming a second image using the non-fluorescent toner in the electrostatic charge image developing toner set according to any one of (((1))) to (((9)));
transferring the first image and the second image onto a recording medium; and
fixing the first image and the second image on the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner set comprising:
a fluorescent toner that contains a fluorescent colorant and has a brightness of 75 or more; and
a non-fluorescent toner that contains no fluorescent colorant,
wherein an amount of Na⁺ on a surface of the fluorescent toner, that is measured by an ion chromatography method, is 0.005 mg/L or more and 0.050 mg/L or less, and a difference between the amount of Na⁺ on the surface of the fluorescent toner and an amount of Na⁺ on a surface of the non-fluorescent toner, that are measured by the ion chromatography method, is 0.050 mg/L or more,
where the amount of Na⁺ is an amount of Na⁺ detected by a method in which 0.5 g of the fluorescent toner or the non-fluorescent toner is weighed, and then added to 100 g of deionized water at 30° C.±1° C., the mixture is dispersed by ultrasonic waves for 30 minutes, and then filtered through a filter, and the filtrate is analyzed by the ion chromatography method.

2. The electrostatic charge image developing toner set according to claim 1,
wherein the difference between the amount of Na⁺ on the surface of the fluorescent toner and the amount of Na⁺ on the surface of the non-fluorescent toner, that are measured by the ion chromatography method, is 0.100 mg/L or more.

3. The electrostatic charge image developing toner set according to claim 1,
wherein the amount of Na⁺ on the surface of the fluorescent toner is 0.010 mg/L or more and 0.040 mg/L or less.

4. The electrostatic charge image developing toner set according to claim 1,
wherein the amount of Na⁺ on the surface of the non-fluorescent toner is 0.050 mg/L or more and 0.500 mg/L or less.

5. The electrostatic charge image developing toner set according to claim 1,
wherein a volume-average particle size of the fluorescent toner is 5.4 μm or more and 6.2 μm or less.

6. The electrostatic charge image developing toner set according to claim 1,
wherein a volume-average particle size of the non-fluorescent toner is 4.3 μm or more and 5.1 μm or less.

7. The electrostatic charge image developing toner set according to claim 1,
wherein the fluorescent colorant includes an azomethine fluorescent pigment having a light emission peak in a wavelength range of 500 nm or more and 550 nm or less in a light emission spectrum.

8. The electrostatic charge image developing toner set according to claim 1,
wherein the fluorescent toner further contains a non-fluorescent pigment.

9. The electrostatic charge image developing toner set according to claim 8,
wherein the non-fluorescent pigment in the fluorescent toner includes a non-fluorescent pigment having a reflection peak in a wavelength range of 480 nm or more and 540 nm or less in a reflection spectrum.

10. An electrostatic charge image developer set comprising:
a first electrostatic charge image developer containing the fluorescent toner in the electrostatic charge image developing toner set according to claim 1; and
a second electrostatic charge image developer containing the non-fluorescent toner in the electrostatic charge image developing toner set according to claim 1.

11. An electrostatic charge image developer set comprising:
a first electrostatic charge image developer containing the fluorescent toner in the electrostatic charge image developing toner set according to claim 2; and
a second electrostatic charge image developer containing the non-fluorescent toner in the electrostatic charge image developing toner set according to claim 2.

12. An electrostatic charge image developer set comprising:
a first electrostatic charge image developer containing the fluorescent toner in the electrostatic charge image developing toner set according to claim 3; and
a second electrostatic charge image developer containing the non-fluorescent toner in the electrostatic charge image developing toner set according to claim 3.

13. An electrostatic charge image developer set comprising:
a first electrostatic charge image developer containing the fluorescent toner in the electrostatic charge image developing toner set according to claim 4; and
a second electrostatic charge image developer containing the non-fluorescent toner in the electrostatic charge image developing toner set according to claim 4.

14. An electrostatic charge image developer set comprising:
a first electrostatic charge image developer containing the fluorescent toner in the electrostatic charge image developing toner set according to claim 5; and
a second electrostatic charge image developer containing the non-fluorescent toner in the electrostatic charge image developing toner set according to claim 5.

15. An electrostatic charge image developer set comprising:
a first electrostatic charge image developer containing the fluorescent toner in the electrostatic charge image developing toner set according to claim 6; and
a second electrostatic charge image developer containing the non-fluorescent toner in the electrostatic charge image developing toner set according to claim 6.

16. An electrostatic charge image developer set comprising:
a first electrostatic charge image developer containing the fluorescent toner in the electrostatic charge image developing toner set according to claim 7; and
a second electrostatic charge image developer containing the non-fluorescent toner in the electrostatic charge image developing toner set according to claim 7.

17. A toner cartridge set comprising:
a first toner cartridge that includes a container containing the fluorescent toner in the electrostatic charge image developing toner set according to claim 1; and
a second toner cartridge that includes a container containing the non-fluorescent toner in the electrostatic charge image developing toner set according to claim 1,
wherein the toner cartridge set is attachable to and detachable from an image forming apparatus.

18. A process cartridge comprising:
a first developing unit containing the first electrostatic charge image developer in the electrostatic charge image developer set according to claim 10; and
a second developing unit containing the second electrostatic charge image developer in the electrostatic charge image developer set according to claim 10,
wherein the process cartridge is attachable to and detachable from an image forming apparatus.

19. An image forming apparatus comprising:
a first image forming unit that forms a first image using the fluorescent toner in the electrostatic charge image developing toner set according to claim 1;
a second image forming unit that forms a second image using the non-fluorescent toner in the electrostatic charge image developing toner set according to claim 1;
a transfer unit that transfers the first image and the second image onto a recording medium; and
a fixing unit that fixes the first image and the second image on the recording medium.

20. An image forming method comprising:
forming a first image using the fluorescent toner in the electrostatic charge image developing toner set according to claim 1;
forming a second image using the non-fluorescent toner in the electrostatic charge image developing toner set according to claim 1;
transferring the first image and the second image onto a recording medium; and
fixing the first image and the second image on the recording medium.
